(19) United States
(12) Patent Application Publication
(10) Pub. No.: US 2010/0156956 A1
(43) Pub. Date: Jun. 24, 2010

(54) GRAYSCALE CHARACTERISTIC FOR NON-CRT DISPLAYS

(76) Inventors: Thomas E. Madden, Fairport, NY (US); John P. Spence, Webster, NY (US); John T. Keech, Penfield, NY (US); Esther M. Betancourt, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 12/639,492

(22) Filed: Dec. 16, 2009

Related U.S. Application Data
(60) Provisional application No. 61/138,976, filed on Dec. 19, 2008.

(51) Int. Cl. G09G 5/10

(52) U.S. Cl. 345/690

(57) ABSTRACT

A method for generating a target display characteristic for a non-CRT display device includes establishing a sequence of luminance-factor values corresponding to original-scene neutrals. The luminance-factor values are converted to corresponding Rec. 709 signal values. The luminance-factor values are then mapped according to a desired system tone reproduction characteristic to corresponding luminous intensity values to be reproduced by the non-CRT television display device. The target display characteristic is generated by relating the corresponding Rec. 709 signal values to corresponding luminous intensity values.

### CROSS REFERENCE TO RELATED APPLICATIONS

This application claims the benefit of U.S. Provisional Patent Application 61/138,976 filed on Dec. 19, 2008, which is incorporated herein by reference.

### TECHNICAL FIELD

The present invention relates generally to display devices. More particularly, the present invention relates to non-CRT display devices. Still more particularly, the present invention relates to a method and system for producing a grayscale characteristic for non-CRT display devices.

### BACKGROUND

In the broadcast video system, original motion image sequences are captured using an image-capture means, such as a broadcast video camera, which produces image-bearing signals. The image-bearing signals produced by the camera typically are encoded according to the ITU-R BT.709 broadcast-video encoding specification (hereinafter Rec. 709), and the encoded image-bearing signals are used to produce a displayed motion image sequence on a television receiver or other image display device such as, for example, a digital projector, digital picture frame, or a portable video playback device. In the foregoing discussion, references made to a scene, image, or images are understood to apply also to motion image sequences.

Rec. 709 is an image-capture and encoding specification based on a set of reference color primaries and an optoelectronic transfer characteristic. These attributes define the relationship between the color stimuli in original motion image sequences and the corresponding encoded signal values that a Rec. 709 compliant video camera or video signal source would deliver for captures of those stimuli.

FIG. 1 illustrates the optoelectronic transfer for the Rec. 709 encoding specification. The Rec. 709 encoding specification is described by the following equations:

For L<0.018, V=4.5L

For L≧0.018, V=1.099L^{0.45}−0.099

where L is the luminance-factor value corresponding to an original color stimulus (with L=1.0 corresponding to that of a diffuse scene white), and V is the corresponding camera output voltage or signal value, normalized so that a scene white produces an output voltage or signal value of 1.0. In order for the broadcast video system to capture and appropriately reproduce images comprised of both neutral (i.e. achromatic or gray) and non-neutral (i.e. non-achromatic or colored) stimuli, the system must function on a trichromatic basis, i.e. the image capture, signal processing and image formation functions of the broadcast video system must utilize at least three imaging channels, typically corresponding to red, green, and blue color-image information. The Rec. 709 optoelectronic transfer then applies to each of the system's red, green, and blue image-capture signals. The CIE Standard Illuminant D65 defines the reference white chromaticity for the Rec. 709 encoding specification. When original-scene colors are spectrally nonselective neutrals illuminated by a light source approximating CIE Standard Illuminant D65, the corresponding Rec. 709 red, green, and blue image-bearing signal values produced by a video camera or video signal source are numerically equal in all three channels. Such trichromatic video signal values are commonly denoted as R′G′B′, the prime denoting the nonlinear relationship between original-scene luminance-factor values and the resulting signal values, as specified by the Rec. 709 optoelectronic transfer. So for neutral scene objects, the values R′, G′, B′, and V all are numerically equal. In the foregoing description, the single quantity V is used for convenience, recognizing that the invention also pertains to the red, green, and blue color-image channels.

Further steps in the video-signal encoding process can and typically are performed, such as, for example, conversions from R′G′B′ to lama and chroma components and conversions to digital realizations. By way of example only, in an 8-bit per color-channel digital camera, the image-capture signals may be scaled and quantized so that the resulting digital signal values for a captured white stimulus would be equal to 255 in all three color channels, and the resulting digital signal values for captured achromatic gray colors of luminance-factor values lower than that of a diffuse white, to correspond to numerically discrete integer values between 0 and 255. Other digital scaling may also be employed.

Providers of encoded motion image content for video broadcast or distribution are motivated to adhere to the Rec. 709 encoding specification in order that the displayed images are compatible in overall visual appearance with displayed images generated by encoded signals from other video signal providers. In turn, receivers of broadcast-compatible video signals are motivated to interpret Rec. 709 signals according to the Rec. 709 specification. In this way, the same output color-signal processing, embodied typically in the television or other display device, can be applied to broadcast video image signals from all sources and providers with predictable and consistent results across signal sources, as long as the Rec. 709 specification applies to the generation of the video signals.

The ITU-R BT.709 specification defines only the image-capture and encoding attributes of a broadcast-compatible video signal in terms of the relationship between the colorimetry of original-scene color stimuli and the corresponding R′G′B′ encoded signal values resulting from the capture, signal generation, and numerical encoding of those stimuli using an image-capturing means such as a broadcast video camera. The specification does not describe how the encoded signal values are to be used to create reproduced images. The specification does not specify the relationship between encoded signal values and the colorimetry of reproduced images produced from the encoded signals, and under what conditions those reproduced images should be viewed by an observer. So, the reproduced colorimetry and resulting color appearance of images displayed from broadcast-compatible video signals are open to interpretation. Specifically, the reproduced colorimetry will depend on the calorimetric characteristics of the image-reproducing means (e.g. a CRT, LCD, or other type of display technology), determined principally by its color primaries, reference white point, grayscale characteristic and other internal color-signal processing. The resulting color appearance will be influenced by the conditions under which the displayed image's reproduced colorimetry will be viewed, which affects the relationship between the displayed colorimetry and its color appearance.

Even though the Rec. 709 specification does not describe the reproduced colorimetry and color appearance of displayed video images, several references make assumptions regarding the reproduced colorimetry and color appearance of displayed video images. In an article entitled “Colorimetry for HDTV” by LeRoy DeMarsh, the author states the opto-electronic transfer function for broadcast video, i.e. that specified by Rec. 709, “is the sort of function currently implemented in many high quality broadcast color TV cameras and is known to produce high quality pictures on current TV monitors.” (page 2). At the time the article was published, virtuall_{y} all television receivers and monitors used CRT display technology. The grayscale characteristic of typical CRT displays is well known in the art, and the relationship between the R′G′B′ input signals and the resulting output luminances on the display generally obeys a straightforward power-law relationship, given by the value of an exponent, gamma. Charles Poynton, in “Digital Video and HDTV: Algorithms and Interfaces” states on p. 264 that “Rec. 709 encoding assumes that encoded R′G′B′ signals will be converted to tristimulus values at a CRT (or some other display device) with a 2.5-power function.”

A power-law equation relating the input signals R′=G′=B′ (or V as discussed earlier) and the output R=G=B relative luminous intensity values (I) for a typical CRT-type display with a luminance dynamic range of 1000:1 intended for broadcast-video applications and having a gamma of 2.5 is defined by the equation/=0.999V^{2.5}+0.001. This relationship is shown graphically in FIG. 2. Since the Rec. 709 encoding specification is predicated on subsequent display of encoded image-bearing signals for motion image sequences on a display having a typical gamma or power-law relationship, it is useful to determine and examine the relationship between a luminance-factor sequence of original-scene neutrals and their reproductions for the broadcast video system. Such a relationship is referred to as a system tone reproduction characteristic.

FIG. 3 depicts an exemplary process whereby a video system tone reproduction characteristic can be derived relating the luminance-factor values for neutrals in original motion-image sequences, and the corresponding relative luminous intensity values as they are reproduced by a typical broadcast video system consisting of a video camera conforming to the Rec. 709 standard, and a typical CRT display comprising a grayscale characteristic corresponding to that described by Charles Poynton. The relationship is determined by mapping a sequence of R=G=B original-scene luminance-factor values, corresponding to a tonal range from black to white, to corresponding Rec. 709 encoded values. The Rec. 709 encoded values are then converted to output luminous intensity values according to a typical CRT display grayscale characteristic. The process also can be determined mathematically by first applying the Rec. 709 optoelectronic transfer equations to a sequence of original-scene luminance-factor values for a series of neutrals ranging from black to white to derive Rec. 709 signal values, and subsequently applying the CRT grayscale characteristic equation to the Rec. 709 signal values to derive reproduced relative luminous intensity values.

The resulting system tone reproduction characteristic shown in FIG. 4 depicts the negative logarithm of the reproduced luminous intensity values versus the logarithm of the original-scene luminance-factor values. It is useful to depict the characteristic in logarithmic terms as these values better correlate to visual sensations, as explained, recommended, and demonstrated in the book by Edward J. Giorgianni and Thomas E. Madden entitled “Digital Color Management: Encoding Solutions”, Prentice Hall 1998 (ISBN 0201634260).

Also shown in FIG. 4 is a reference line of slope equal to 1.0. As can be seen, the video system tone reproduction, relating the original-scene color stimuli to their reproductions, has an overall contrast, or slope, greater than 1.0 throughout the majority of the characteristic save for the dark shadow region, in order to compensate for the physical, psychological, and psychophysical visual phenomena involved in the viewing of reproduced images. Such phenomena include but are not limited to viewing flare, lateral-brightness adaptation, and general-brightness adaptation. These and other relevant perceptual factors and methods for compensating for them in color imaging systems are described in detail in the book by Edward J. Giorgianni and Thomas E. Madden entitled “Digital Color Management: Encoding Solutions”, Prentice Hall 1998 (ISBN 0201634260).

With the recent advent of alternate display technologies, such as, for example, LCD, plasma, Organic Light Emitting Diode (OLED), and digital projection, manufacturers of television display devices employing such technologies typically include means for causing the alternate display technology to more-or-less function according to a typical CRT-based power-law relationship in order to maintain compatibility with the existing broadcast-video system and to produce displayed images more or less compatible with those that would be displayed on a CRT for which the encoded signal is intended. Not doing so would run the risk of introducing a television display device employing alternate display technology to reproduce motion image sequences in a fashion ₜhat would appear quite different and quite possibly visually objectionable when compared to the same broadcast video signal displayed using a high-quality CRT-based television display. While it is recognized that alternate display technologies may exhibit and employ colorimetric features unachievable by existing CRT-based technologies (e.g. wider color gamut), the foregoing discussion applies to the overall tone reproduction characteristic.

FIG. 5 illustrates the grayscale characteristics for a particular LCD display system and a reference gamma 2.5 CRT display expressed in terms of luminance-factor values versus input equal RGB code value. Plot 500 represents the grayscale characteristic for the LCD display and plot 502 the grayscale characteristic for the reference gamma 2.5 CRT display. All other factors being equal, simply displaying a particular Rec. 709-encoded image on the LCD display having the grayscale characteristic depicted in the figure would produce displayed-image relative colorimetry quite different from that for the reference CRT display system grayscale. Specifically, the midscale and highlight tones of the image would be reproduced relatively lighter and generally higher in contrast on the LCD display system (region 504 of plot 500) than they would be reproduced on the reference CRT display system as intended. Further, the shadow tones of the image would be displayed relatively darker on the LCD display system (region 506 of plot 500) than they would be on the CRT reference display system. Further still, some portions of the shadow tones would be higher in contrast and some portions of the shadow tones would be lower in contrast on the LCD display system than on the CRT reference display system. This is just one example.

A particular display device grayscale characteristic can vary considerably from this example depending on the basic display technology employed (LCD, plasma, OLED), the sub-technologies within a given basic technology (twisted nematic vs. in-plane switching LCD technologies, for example), the differences caused by manufacturing variation in individual units of the same type, as well as the differences caused by the particular digital or analog electronics and software or firmware integrated with the display panel in the device. These differences can produce significantly different visual results.

Since alternate non-CRT display technologies may or may not adhere to a power-law grayscale characteristic comparable to that of a CRT-based display for which the Rec. 709 encoded signal is presumably optimized, television display device manufactures typically employ lookup tables as part of the television's video signal processing. The combination of the lookup table and the particular display panel's grayscale characteristic generally corresponds substantially to that of a high-quality CRT-based display, which can be used together with Rec. 709 encoded signals with the expectation that the displayed image will exhibit a tonal relationship to the original scene colors corresponding essentially to that of the system tone reproduction characteristic of FIG. 4. This functionality is typically provided by the video signal processing circuitry incorporated into today's television sets by providing television system integrators tools for generating such lookup tables. The lookup tables are designed for and used in conjunction with a particular display panel, and the combination effectively functions according a CRT-based power-law grayscale characteristic, with the gamma of the power law relationship generally able to be specified by the system integrator according to preference, thus providing the possibility of differentiation of their television set from the competition.

FIG. 6 illustrates an exemplary process for deriving such lookup tables. A sequence of R=G=B Rec. 709 input signal value triads, which sample and span a signal-value range to adequately describe a typical reference display system grayscale, are converted to corresponding reference relative RGB intensity values (S1). This conversion can be via a lookup table designed to emulate the reference display system grayscale. Alternatively, the conversion may be accomplished by employing the equations given earlier referencing a CRT display having a gamma of 2.5 as described in the prior art. Alternatively, the conversion may be accomplished by applying the R=G=B input signal values to an actual display system, the physical colorimetric characteristics of which correspond to those defined for the reference display system, measuring the resulting displayed CIE colorimetry corresponding to each input-signal triad, and converting the measured colorimetry to corresponding RGB reference relative intensity values expressed in terms of the Rec. 709 reference primaries using primary conversion matrix techniques described in the art.

Next, the reference RGB relative intensity triads may be converted to colorimetrically equivalent RGB relative intensity triads expressed in terms of the actual device RGB color primaries, again using color primary conversion techniques described in the prior art (S2). The actual device RGB relative intensity values are then converted to corresponding RGB device input signal values (S3). This conversion is accomplished by a mapping or lookup table process using the device grayscale characteristic expressed in terms of device RGB relative intensity values and corresponding device input signal values. Finally, a compensation lookup table or other compensation function is derived by forming a relationship between Rec. 709 input signal values and corresponding actual device input signal values (S4).

Use of such a compensation relationship or lookup table in a display device will cause the device's grayscale characteristic to emulate that of a reference display device, as illustrated in FIG. 7. As shown in FIG. 7, input Rec. 709 signal values are first transformed by the grayscale compensation lookup tables implemented in the hardware, firmware, or software of the display device converting them into corresponding actual display device signal values. The corresponding display device signal values, when applied to the actual display device imaging panel having the depicted device grayscale characteristic, produce RGB relative intensity values on the display device that are colorimetrically-equivalent to the reference RGB relative intensity values had the input Rec. 709 code values been applied to the reference television display system.

While the incorporation of such compensation lookup tables have enabled the rapid conversion of the television display market to non-CRT based technology, the range of tonal variation that can be effected using various power-law relationships is quite limited, with only a few degrees of freedom available to the system integrator. Furthermore, the use of power-law relationship grayscales has done little to take advantage of the possibilities afforded using alternate display technologies and the many degrees of freedom made available by the incorporation of digital lookup table processing capability.

### SUMMARY

A method for generating a target display characteristic for a non-CRT display device includes establishing a sequence of luminance-factor values corresponding to original-scene neutrals. The luminance-factor values are converted to corresponding Rec. 709 signal values. The luminance-factor values are then mapped according to a desired system tone reproduction characteristic to corresponding luminous intensity values to be reproduced by the non-CRT television display device. The target display characteristic is generated by relating the corresponding Rec. 709 signal values to corresponding luminous intensity values.

### BRIEF DESCRIPTION OF THE DRAWINGS

Embodiments of the invention are better understood with reference to the following drawings. The elements of the drawings are not necessarily to scale relative to each other.

FIG. 1 illustrates the optoelectronic transfer for the Rec. 709 encoding specification;

FIG. 2 depicts an exemplary relationship between input signals R′=G′=B′ and output R=G=B relative luminous intensity values for a typical prior art CRT-type display;

FIG. 3 illustrates an exemplary process whereby a video system tone reproduction characteristic can be derived in accordance with the prior art;

FIG. 4 depicts a resulting system tone reproduction characteristic derived using the process shown in FIG. 3;

FIG. 5 illustrates the grayscale characteristics for a particular LCD display system and a reference gamma 2.5 CRT display system expressed in terms of luminance-factor values versus input equal ROB code value in accordance with the prior art;

FIG. 6 depicts an exemplary process for deriving lookup tables for a non-CRT display technology in accordance with the prior art;

FIG. 7 illustrates a method for using a lookup table in a display device to cause the grayscale characteristic of the display device to emulate that of a reference display device in accordance with the prior art;

FIG. 8 is a simplified block diagram of a display system in an embodiment in accordance with the invention;

FIG. 9 illustrates an exemplary CRT-based broadcast video system tone reproduction characteristic and an improved system tone reproduction in logarithmic terms in an embodiment in accordance with the invention;

FIG. 10 is a graphical illustration of a method for generating a target display characteristic in an embodiment in accordance with the invention;

FIG. 11 depicts a derived target display grayscale characteristic co-plotted with a typical CRT power-law characteristic in an embodiment in accordance with the invention;

FIG. 12 illustrates power-law curves in an embodiment in accordance with the invention;

FIG. 13 depicts a comparison of the relative luminance differences between a target grayscale characteristic and a typical gamma 2.5 power-law grayscale characteristic in an embodiment in accordance with the invention;

FIG. 14 illustrates a first grayscale tracking plot for a non-CRT display device in an embodiment in accordance with the invention;

FIG. 15 depicts a second grayscale tracking plot for a non-CRT display device in an embodiment in accordance with the invention;

FIG. 16 illustrates first grayscale compensation lookup tables for a particular display device in an embodiment in accordance with the invention; and

FIG. 17 depicts second grayscale compensation lookup tables for the same particular display device used in the embodiment of FIG. 16.

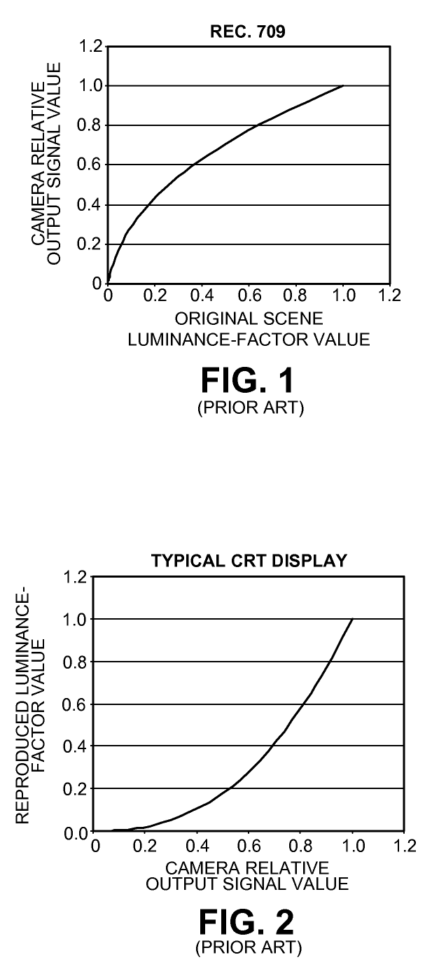

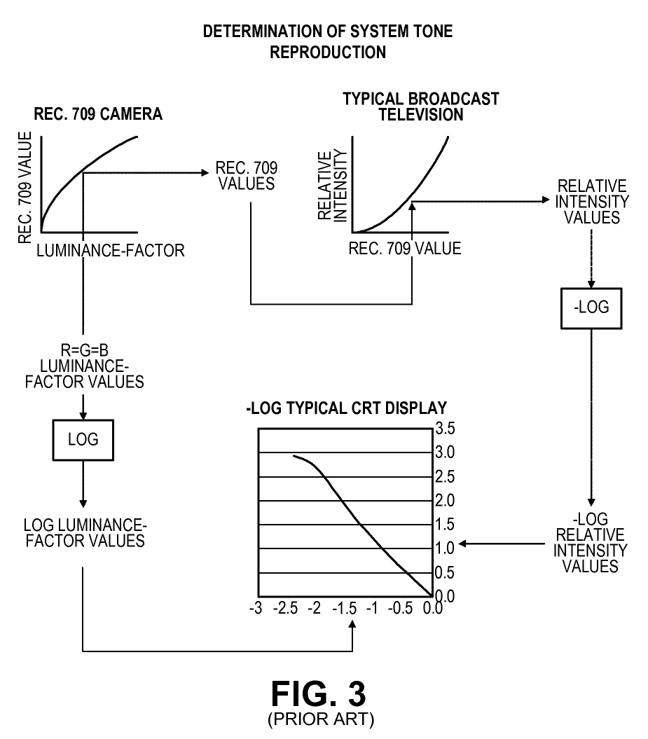

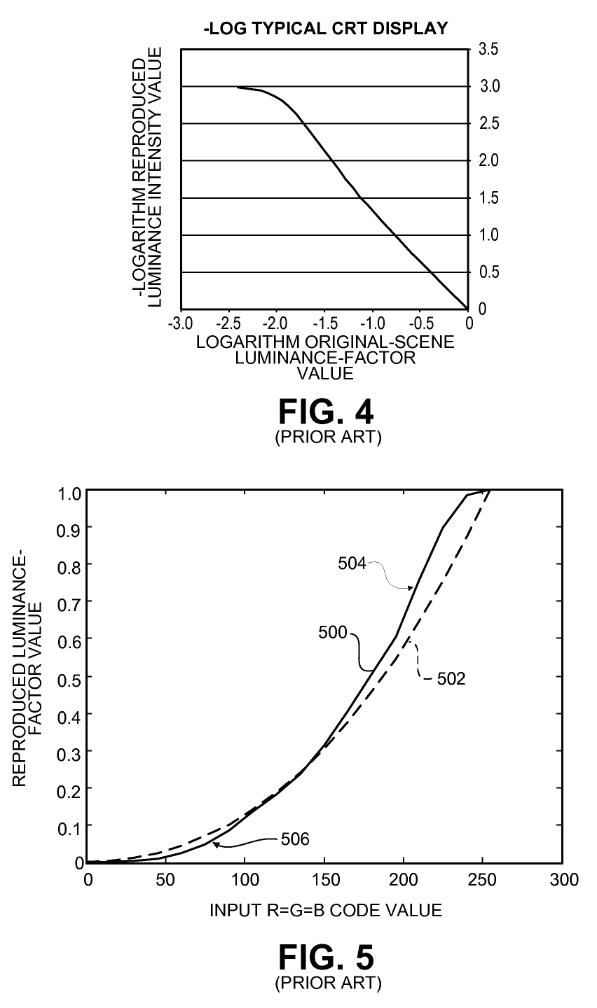

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means either a direct electrical connection between the items connected, or an indirect connection through one or more passive or active intermediary devices. The term “circuit” means either a single component or a multiplicity of components, either active or passive, that are connected together to provide a desired function. The term “signal” means at least one current, voltage, or data signal.

Referring to the drawings, like numbers indicate like parts throughout the views.

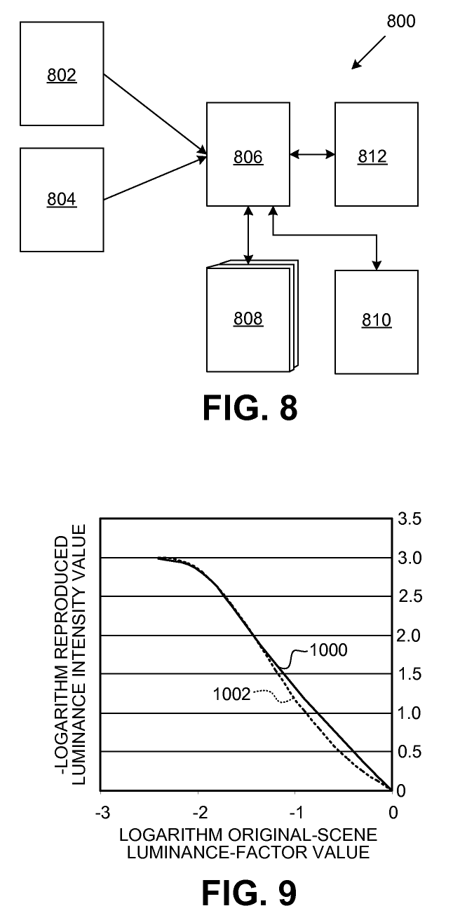

FIG. 8 is a simplified block diagram of a display system in an embodiment in accordance with the invention. Display system 800 includes image capture device 802, one or more other types of input devices 804, and processor 806. Image capture device 802 or input device 804 transmit one or more image files expressed in terms of the Rec. 709 encoding specification to processor 806 in an embodiment in accordance with the invention.

Processor 806 is configured, for example, as a microprocessor, a central processing unit (CPU), an application-specific integrated circuit (ASIC), a Field Programmable Gate Array (FPGA), a digital signal processor (DSP), or other processing device, or combinations of multiple such devices, in one or more embodiments in accordance with the invention. Processor 806 may store the one or more image files in memory 808. Memory 808 is implemented as any type of memory, such as, for example, random access memory (RAM), DRAM, SDRAM, flash memory, disk-based memory, removable memory, or other types of storage elements, in any combination, in an embodiment in accordance with the invention.

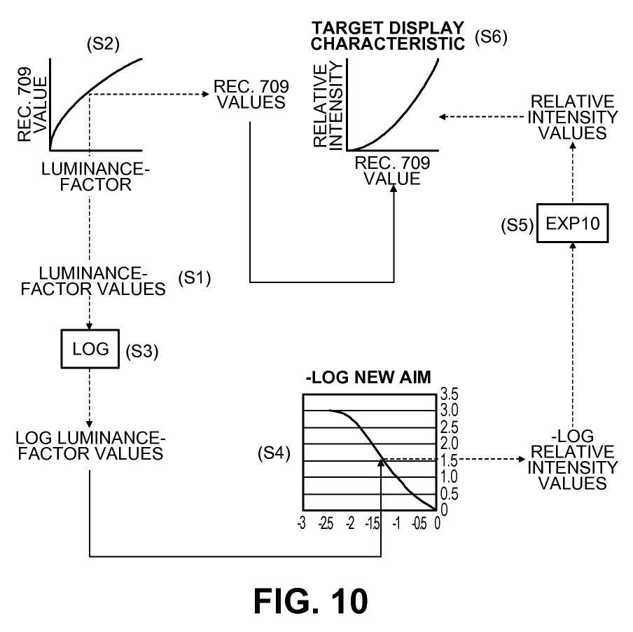

Communications port 810 is an input/output port for communicating with other devices and networks, such as, for example, various on-screen controls, buttons or other user interfaces, network interfaces, and remote or voice control interfaces. And finally, display 812 is used to display the one or more image files. Display 812 is configured as a liquid crystal display (LCD), an organic light emitting diode (OLED) display, a plasma display panel (PDP), a projection display, or other non-CRT display technology in one or more embodiments in accordance with the invention. When processor 806 processes the one or more image files using the target grayscale characteristic derived pursuant to the method shown in FIG. 10, display 812 will display the one or more image files with improved grayscale compensation.

Because today's alternate technology non-CRT television displays are much higher in their overall peak luminance, generally fill more of the observers' field of view, and typically operate at much higher overall correlated color temperatures than a CRT display and associated viewing conditions at the time the Rec. 709 standard was developed, the relationship between displayed television colorimetry and its color appearance most likely differs in today's typical viewing situations versus that of the broadcast television conditions during which CRT displays were prevalent. Therefore, a different target display characteristic is needed to take advantage of these new factors. The present invention provides method for generating the target display characteristic for a non-CRT display device. The target display grayscale characteristic is produced by the combination of grayscale compensation lookup tables and the display panel's native or actual grayscale characteristic. Use of the target display characteristic results in visually preferred displayed images from Rec. 709 signals compared to that of typical non-CRT televisions where the relative luminance-factor values of their reproduced neutrals are related according to a gamma or power-law relationship, which may or may not include scalar and offset factors.

Referring now to FIG. 9, there is shown an exemplary CRT-based broadcast video system tone reproduction 1000 and an improved system tone reproduction 1002 in logarithmic terms in an embodiment in accordance with the invention. The overall midscale contrast is somewhat higher than for the CRT-based system 1000. This higher midscale contrast of the improved tone reproduction characteristic 1002 results from higher relative luminances produced in the image highlight and lighter midscale areas. Such differences result in a visually preferred tone reproduction characteristic with excellent reproduction of midscale tonal variation, particularly in midtones and including skintones. The higher overall neutral midscale contrast, since it is typically applied to RGB signals within the television display device, also increases the constituent RGB color contrasts and results in higher color saturation in the reproduction of colored objects. This is visually preferred by observers. Moreover, since this higher midscale contrast is accomplished by increasing the luminances of the lighter midscale and highlight regions of the system tone reproduction characteristic relative to that of the typical CRT-based system, the resulting displayed image is of overall higher integrated luminance, which will be seen to be brighter overall compared to an image displayed according to the typical tone reproduction, even at an equivalent peak white luminances. As will be seen later, the overall brighter image can overcome a possible small reduction in peak white luminance necessary to achieve a white point chromaticity seen as visually achromatic.

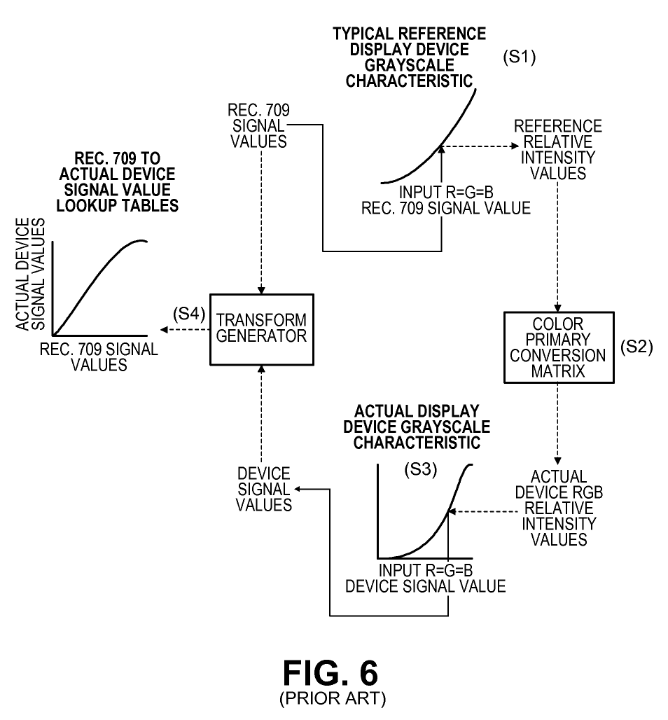

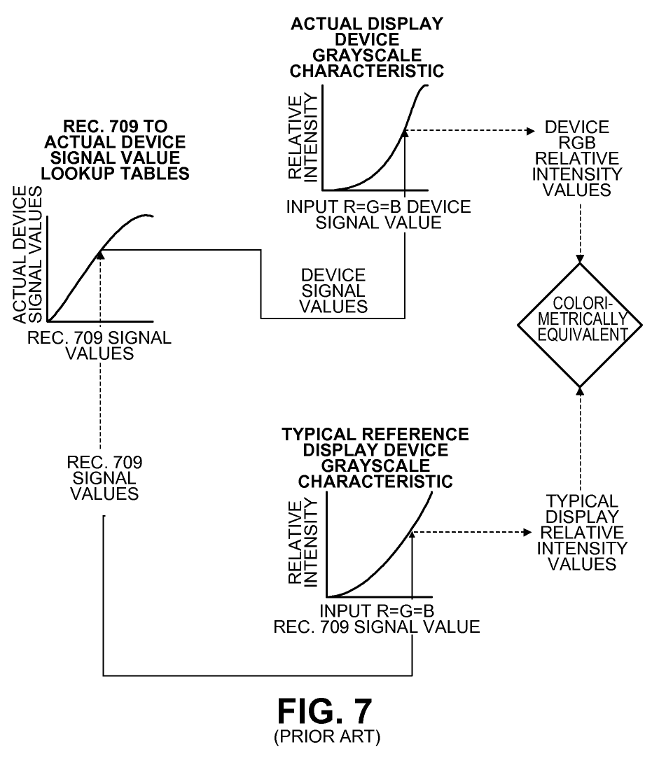

Achieving such an overall tonal characteristic requires a unique target display characteristic to be used in the lookup table generation process described with reference to FIG. 6. Such a target characteristic can be derived according to the method depicted in FIG. 10. Initially, a sequence of luminance-factor values corresponding to original-scene neutrals is established (S1). These luminance-factor values are converted to corresponding Rec. 709 signal values using the optoelectronic transfer characteristic equations set forth in Rec. 709 (S2). The luminance-factor values also may be optionally transformed by taking their logarithm, if the system tone reproduction characteristic itself is expressed in logarithmic terms (S3).

The log luminance-factor values are then mapped according to the desired system tone reproduction characteristic to corresponding log luminous intensity values that are to be reproduced by the non-CRT television display device (S4). The log luminous intensity values may be transformed to relative intensity values by taking their antilogarithms, if the system tone reproduction characteristic is again expressed in logarithmic terms (S5). Then a target display grayscale characteristic is derived relating Rec. 709 encoding values to corresponding relative intensity values (S6).

FIG. 10 depicts only curve. Those skilled in the art will recognize a curve is generated for each color input signal of a display. For example, the method of FIG. 6 will derive three curves for an RGB display.

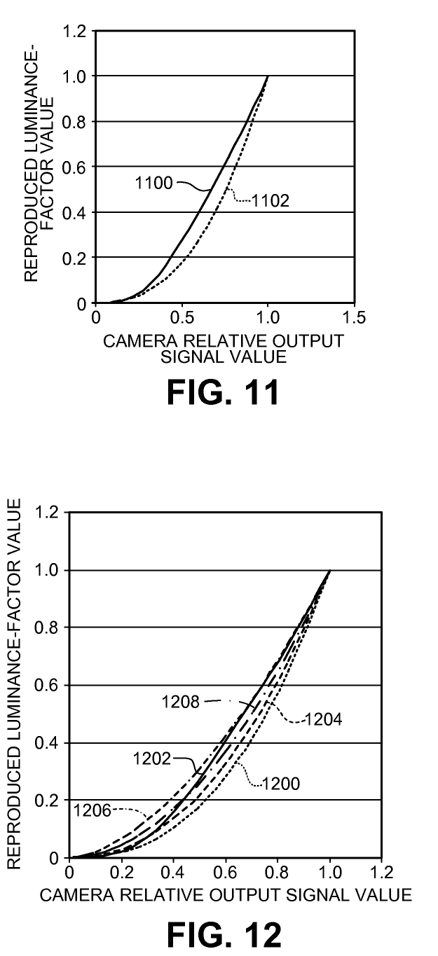

Referring now to FIG. 11, there is shown a derived target display grayscale characteristic co-plotted with the typical CRT power-law characteristic in an embodiment in accordance with the invention. The improved target characteristic 1100 is higher in overall relative luminance versus the typical CRT grayscale characteristic 1102, resulting in visually preferred tone reproduction. Again, this overall brighter image overcomes a small reduction in peak white luminance necessary to achieve a white point chromaticity seen as visually achromatic.

The nature of the improved display grayscale characteristic of the present invention is apparent in FIG. 12 wherein it is illustrated that such a target display characteristic cannot be parameterized according to a simple power-law relationship of any single gamma value. The power-law curves shown in the embodiment of FIG. 12 follow the form of the equations given earlier in this description using a luminance dynamic range of 1000:1 given by the parameters 0.999 and 0.001 in the equations. Only the value of the exponent gamma is varied. The typical CRT display characteristic 1200 (gamma 2.5) described earlier is shown along with the target grayscale characteristic 1202 of the present invention. A power-law grayscale characteristic comprising a gamma value of 2.2 (1204) provides a reasonable approximation to the target grayscale characteristic only in the shadow and darker midscale regions (i.e., x-axis luminance-factor values from approximately 0.0 to 0.3). However, the gamma 2.2 power-law grayscale characteristic 1204 is substantially darker in the lighter midscale and highlight regions, and results in displayed images that visually appear much too dark in the upper scale and too high in upper-scale luminance contrast.

A power-law grayscale characteristic comprised of a lower value of gamma, e.g. 1.7 as shown as plot 1206 in FIG. 12, conversely provides a reasonable approximation to the upper scale (lighter) portion of the target grayscale characteristic 1200 of the present invention. However, the gamma 1.7 power-law grayscale characteristic 1206 is substantially lighter in the shadow and midscale regions (i.e. x-axis luminance-factor values from approximately 0.0 to 0.7), and results in displayed images that visually appear much too light in the shadows and too low in midscale luminance contrast. Finally, also shown in FIG. 12 is a power-law grayscale characteristic comprised of a gamma value 1.95 (plot 1208), in between 1.7 and 2.2, which is seen to fit only the black, white, and single gray point of the target grayscale characteristic 1202 of the present invention. In this case, darker colors are displayed lighter and the lighter colors are displayed darker than would be using the target grayscale characteristic 1202.

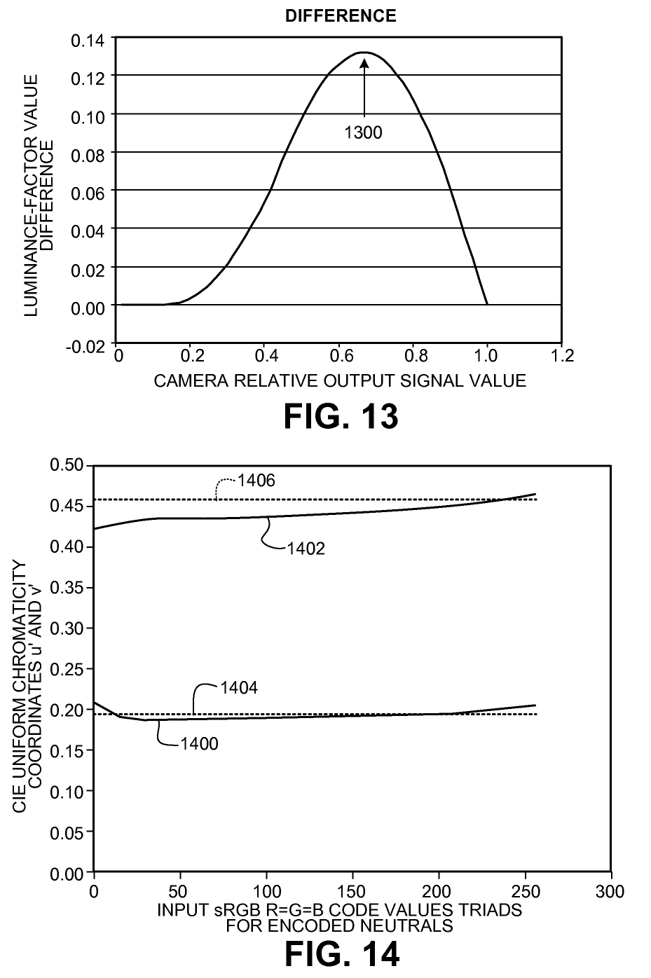

A comparison showing the relative luminance differences between the target grayscale characteristic of the present invention and a typical gamma 2.5 power-law grayscale characteristic is shown in FIG. 13 plotted against the corresponding Rec. 709 R=G=B input signal value. As the differences are all positive, it is seen that the luminances of the target grayscale characteristic are relatively higher than they are for the typical power-law characteristic. The peak difference 1300 falls within a relative input Rec. 709 signal-value range of 0.5 to 0.8. The curvature of the difference plot 1302 is somewhat asymmetrical and could be made symmetrical about the peak or reflected left to right about the peak from that shown depending on visual preferences in an embodiment in accordance with the invention. Likewise, the width of the difference distribution also could be adjusted based on visual preferences.

The target grayscale characteristic of the present invention provides an improved television display device wherein scene neutrals, captured and encoded according to the ITU-R BT.709 standard are reproduced in a visually preferred manner according to the target grayscale characteristic. The improved system tone reproduction characteristic has the chromaticity coordinates of the reproduced neutrals lying substantially along the continuum of chromaticities corresponding to CIE standard daylight illuminants. The chromaticies are constant throughout a majority of the display luminance dynamic range. The reproduced neutrals appear achromatic to an observer adapted to the television viewing environment.

For example, an LCD native grayscale typically exhibits a tendency departing from that of an achromatic, as shown in the grayscale tracking plot of FIG. 14. In FIG. 14, the input sRGB R=G=B code values triads for encoded neutrals are plotted along the horizontal axis, and the CIE uniform chromaticity coordinates u′ and v′ are plotted along the y-axis, the u′ values plotted in 1400, and the v′ values plotted in 1402. The dotted lines 1404, 1406 represent an achromatic reference corresponding to the u′ and v′ chromaticity coordinates, respectively, for CIE standard illuminant D75. The solid lines depict the u′ v′ chromaticities reproduced for that input neutral scale for a particular commercially available digital picture frame employing an LCD panel similar to those incorporated in LCD television receivers. While the reproduced u′ chromaticities are more or less constant throughout the grayscale, as evidenced by the horizontal nature of the plot, the reproduced v′ coordinate is not constant throughout the grayscale, being lower in value at the dark end of the characteristic and higher in value at the light end. The result to the observer is a grayscale characteristic where in the highlights may appear somewhat greener than the shadows, or conversely, the shadows may appear somewhat more magenta than the highlights. The above is just one example of how a grayscale characteristic can deviate from a condition of consistent chromaticity and result in visual artifacts.

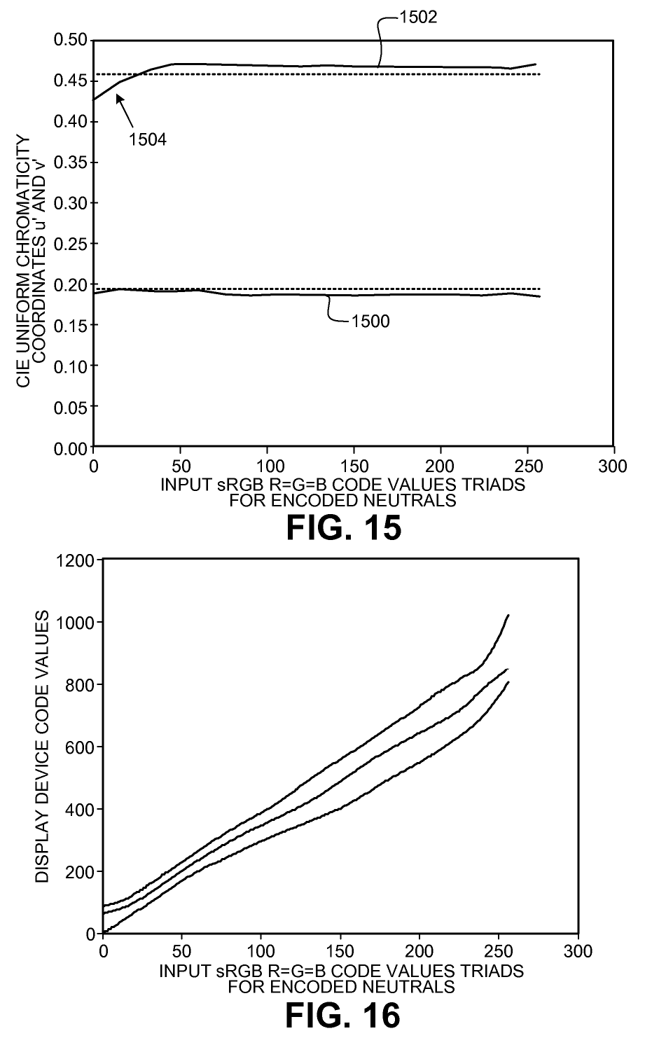

Three one-dimensional compensation lookup tables are used to impart a desired overall shape and relative luminance level to the effective grayscale characteristic in an embodiment in accordance with the invention. And as described with reference to FIG. 15, these lookup tables are also exploited to impart a condition of constant chromaticity throughout the curve.

In some embodiments, it is necessary to display some amount of light from one or two of the color primaries in order to produce an achromatic black color corresponding in chromaticity to that of the rest of the grayscale. When this is done for the black point, the light emitted by the one or two primaries required to produce the achromatic black have some luminance component associated with them, thus increasing the minimum luminance displayable by the display device and reducing the contrast ratio achievable. Observers may object to this reduction on contrast ratio more than they object to a grayscale that tracks through the majority of its characteristic, but tapers toward the panel black point. An improved grayscale characteristic chromaticity tracking is depicted in FIG. 15, which has the feature of achromatic grayscale tracking throughout the majority of the grayscale, as evidenced by the substantially horizontal portions of plots 1500, 1502. Plot 1500 represents CIE standard daylight D75, while plot 1502 represents the Kodak 8DVT-2 grayscale primaries-051508. The horizontal portions of plots 1500, 1502 indicate constant reproduced chromaticity. A taper 1504 to the chromaticity of the panel black chromaticity at the lowest portion of the grayscale characteristic is also included, as evidenced by the intentional deviation from horizontal in that portion of the curve.

Since the chromaticity of the panel black point can vary from display panel to display panel depending on numerous factors including the backlight which may be employed, the specific panel technology, and any light management films and materials that may be incorporated in the display panel, the nature of the final taper will depend on the chromaticity selected for the achromatic neutral and specific panel black point. Thus, other embodiments in accordance with the invention will have different tapers to the chromaticity of the panel black chromaticity at the lowest portion of the grayscale characteristic.

FIG. 16 depicts first grayscale compensation lookup tables for a particular display device in an embodiment in accordance with the invention. The lookup tables are computed so as to deliver the improved grayscale characteristic of the present invention at a constant chromaticity corresponding to that of CIE standard illuminant D75 throughout the entire characteristic. The horizontal axis represents sRGB input code value and the vertical axis represents display device code values. In the embodiment of FIG. 16, the display device code values are 10-bit values for a particular panel. Different panel code values may use a different number of bits, such as more or less bits than the 10-bits shown.

The above description of grayscale chromaticity tracking with improved black point adjustment used a reference achromatic chromaticity corresponding to that of CIE Standard Illuminant D75. Other embodiments in accordance with the invention can use other reference achromatic chromaticities such as, for example, D65 and D90.

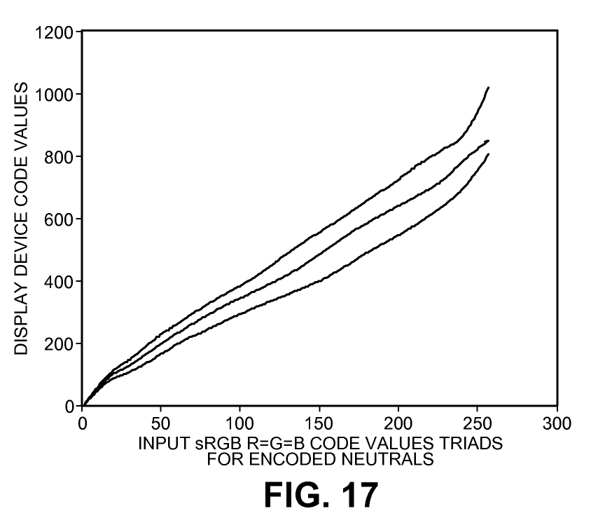

Referring now to FIG. 17, there are shown second grayscale compensation lookup tables for the same particular display device used in the embodiment of FIG. 16. The grayscale compensation lookup tables are computed so as to deliver the improved grayscale characteristic at a constant chromaticity corresponding to that of CIE standard illuminant D75. The grayscale lookup tables additionally provide a taper 1700 in the lower end of the tables to utilize the panel black point and to improve contrast ratio.

Since the chromaticity of the panel black point can vary from panel to panel, depending on numerous factors including, but limited to, the backlight which may be employed, the specific panel technology, and any light management films and materials that may be incorporated in the display panel, the nature of the final taper will depend on the chromaticity selected for the achromatic neutral and specific panel black point.

Today's television displays tend toward higher correlated color temperatures (9000K and higher) for their reproduced whites and neutral colors as compared to the D65 reference white defined for the Rec. 709 video signal encoding standard. Current LCD panel technology produces a native grayscale characteristic at higher correlated color temperatures, and so system integrators and manufacturers are motivated to design their television sets closer to this native color temperature than to the Rec. 709 reference white chromaticity to provide maximum luminance. In other words, designing an LCD TV around a D65 white point necessitates a reduction in luminance in one, or most likely two of the panel's constituent primary colors, which also would reduce the maximum luminance achievable. This change in reference white chromaticity can be handled most successfully if the higher operating reference-white color temperature is selected such that its CIE chromaticity coordinates lie substantially along the chromaticity continuum corresponding to the CIE Standard Daylight illuminant series. Doing so produces reproduced neutrals that are perceived to be achromatic using today's larger higher-luminance panels that more fill the observer's visual field than typically sized CRT displays viewed at more or less the same distance. By establishing the reproduced neutral along this continuum, the reproduction of other important scene colors becomes more straightforward and is accomplished in a visually preferred and natural fashion.

For example, TV manufacturers often quote correlated color temperatures for their white points. However, those skilled in the art will recognize a correlated color temperature of 9000K can relate to a wide variety of reference white chromaticities, many of which may deviate so far from the daylight continuum that it is difficult, if not impossible, for an observer to fully adapt to the color of the reproduced neutral. Instead, the observer perceives an overall color cast in the reproduced images. It is not uncommon for manufactures to use a reference white chromaticity that corresponds to a point along an iso-correlated color temperature line that is decidedly magenta or pink in overall appearance. This causes other problems in color reproduction, especially that of natural foliage and green colors. By shifting the neutral scale in the magenta direction, the greens concomitantly lose much of their chroma and appear devoid of the level of color expected in their reproduction. Again, by establishing the neutral along the daylight chromaticity continuum, such color reproduction problems are avoided.

It is recognized that some televisions in the market include algorithms for adaptively adjusting the effective device grayscale, and thereby the system tone reproduction, by making adjustments to compensation lookup tables, histograms, luminance signals, and the like, based on incoming image-bearing signal spatial, temporal, or tonal statistics. Such algorithms effectively apply modifications to the device grayscale characteristic to improve the visual quality of the final displayed image. Furthermore, display modes, such as those typically denoted as “Normal”, “Vivid”, and the like may include brightness, contrast, and other such modifications. Further yet, the user may, through the television user-interface make modifications to the overall brightness and contrast parameters of the television display device. The present invention is directed toward the static, or native television display grayscale characteristic in the absence of such adaptive algorithms or mode or user modifications. Similar novel device grayscale characteristics, and thereby system tone reproduction characteristics can be generated by adjusting parameters such as the luminance contrast of the device or system tone reproduction, deriving a corresponding device grayscale characteristic, and computing and implementing compensating lookup tables based on the derived characteristic and actual device characteristic, or on the difference between the new original characteristic and the new characteristic. All such modifications and adjustments are within the spirit and scope of the invention described.

Even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

1. A method for generating a target display characteristic for a non-CRT display device, the method comprising:
establishing a sequence of luminance-factor values corresponding to original-scene neutrals;
converting the luminance-factor values to corresponding Rec. 709 signal values;
mapping the luminance-factor values according to a desired system tone reproduction characteristic to corresponding luminous intensity values to be reproduced by the non-CRT television display device; and
generating the target display characteristic by relating the corresponding Rec. 709 signal values to corresponding luminous intensity values.

2. The method as in claim 1, further comprising transforming the luminance-factor values to log luminance-factor values prior to mapping the luminance-factor values according to a desired system tone reproduction characteristic to corresponding luminous intensity values to be reproduced by the non-CRT television display device.

3. The method as in claim 2, wherein mapping the luminance-factor values according to a desired system tone reproduction characteristic to corresponding luminous intensity values to be reproduced by the non-CRT television display device comprises mapping the log luminance-factor values according to a desired system tone reproduction characteristic to corresponding log luminous intensity values to be reproduced by the non-CRT television display.

4. The method as in claim 3, further comprising transforming the log luminous intensity values to relative intensity values by taking an antilogarithms of the log luminous intensity values.

5. The method as in claim 4, wherein generating the target display characteristic by relating the corresponding Rec. 709 signal values to corresponding luminous intensity values comprises generating the target display characteristic by relating the corresponding Rec. 709 signal values to corresponding relative intensity values.
